(19) United States
(12) Patent Application Publication
(10) Pub. No.: US 2011/0022617 A1
(43) Pub. Date: Jan. 27, 2011

(54) FINITE AUTOMATON GENERATION SYSTEM FOR STRING MATCHING FOR MULTI-BYTE PROCESSING

(76) Inventor: Norio Yamagaki, Tokyo (JP)

Correspondence Address: Mr. Jackson Chen, 6535 N. STATE HWY 161, IRVING, TX, 75039, US

(21) Appl. No.: 12/933,504

(22) PCT Filed: Mar. 19, 2009
(86) PCT No.: PCT/JP2009/055515

§ 371 Date: Sep. 20, 2010

(30) Foreign Application Priority Data
Mar. 19, 2008 (JP) 2008-071951

(51) Int. Cl. G06F 17/30

(52) U.S. Cl. 707/758; 707/E17.039

(57) ABSTRACT

An NFA circuit adapted to regular expressions and used for multibyte processing enables independent check of in what position the inputted character string matches.

A 1-byte NFA converting unit (21) stores one or more regular expressions inputted by an input device (1) in a regular expression storage unit (31), sequentially reads out the regular expressions, and converts them into 1-byte processed NFAs with no ε transition.

A multibyte NFA converting unit (22) converts the generated 1-byte processed NFAs into NFAs such that it can be judged in what position the inputted character string to be processed in multibyte matches a pattern on the basis of the operating mode and the number of processing bytes inputted by the input device (1) and processed and stores the NFAs in an NFA storage unit (32).

An HDL converting unit (23) generates a hardware description language (HDL) of the NFA circuit from the state transition information relating to the NFAs inputted from a multibyte NFA converting unit (22).

### TECHNICAL FIELD

The present invention relates to a finite automaton generation system for string matching for multi-byte processing, an automaton circuit generation system, a method of generating the same, a method of generating a circuit, a generation program, a circuit generation program and a pattern matching device using the same, and a finite automaton circuit for string matching for multi-byte processing.

### BACKGROUND ART

All of patents, patent applications, patent publications, scientific articles and the like, which will hereinafter be cited or identified in the present application, will hereby be incorporated by references in their entirety in order to describe more fully the state of the art, to which the present invention pertains.

Conventionally, string matching (pattern match) using a regular expression has been performed using a state transition machine called Finite Automaton (FA).

This FA can be loosely classified into two:

Non-deterministic Fine Automaton (NFA) in which a plurality of state transition destinations exist for an input character in a certain state, and Deterministic Finite Automaton (DFA) in which only one state transition destination exists.

As described in the non-patent document 1, the NFA can usually be generated by constructing a syntax tree from search subject conditions such as a given regular expression and based thereon.

On the other hand, the DFA can be generated from the NFA generated according to the above procedure, however, there is a possibility that the number of states may be increased up to about 2ⁿ against the number n of states of the NFA (non-Patent Document 2).

In general, as a method to obtain pattern match using these FAs on hardware, there is a method in which state transition information is stored in a memory as a state transition table, and pattern matching is performed by making a state transit one by one while referring to the above table.

Since it is necessary to access the memory to obtain transition information each time a state to transition occurs, this memory access becomes a bottleneck for speeding up.

Further, such a method to store an NFA state transition table on memory as above can only perform processing by selecting one transition destination from a plurality of state transition destinations, accordingly, when failing to perform matching in a selected state transition destination, a processing called “backtrack” is required, in which the processing returns to the branched time point to test another candidate, the backtrack itself prevents speeding up.

DFA needs a great deal of the memory capacity because there is a possibility that the number of states explosively increases.

In particular, when performing high-speed pattern matching for a number of regular expression patterns, the above becomes a bottleneck for speeding up and constructing a configuration.

In recent years, methods of performing high-speed pattern matching have been proposed by making the NFA directly into a circuit to be mapped onto a reconfigurable device like a FPGA (Field Programmable Gate Array) as shown in non-Patent Documents 3 to 6 and Patent Documents 1 and 2.

Generally, the NFA includes a special transition called an s transition capable of transiting to the following state without reading the input, in the pattern matching circuit where the NFA is directly incorporated (hereinafter, referred to as an NFA circuit), the NFA including no ε transition has to be used.

An operation to eliminate ε transition from such an NFA is referred to as an ε-closure (non-Patent Documents 1 and 2).

As for a method of making the NFA directly into a circuit, a variety of methods have been proposed such as a method to generate the NFA circuit in which the NFA is directly incorporated from a regular expression through a syntax tree and a method to configure the NFA circuit after converting the regular expression into the NFA. For example, when considering the NFA for the regular expression “a(bc)*(d|e)” as shown in FIG. 24, the NFA circuit is configured as a circuit like FIG. 25.

Here, ‘*’ included in the above-mentioned regular expression is a meta-character denoting a match of 0 times or more, and ‘|’ denotes OR, a white arrow in FIG. 24 denotes an initial state, and a state denoted by a double circle denotes a final state.

As shown in FIG. 25, from the state 0 to the state 4 of the original NFA (FIG. 24) can be achieved by from registers 200 to 204 in the NFA circuit, respectively, when the value of each register is ‘1’, the relevant state is judged to be active.

A character (1 byte) input as data is compared with a character (in the figure, the character written in a comparator) that is a transition condition in comparators 300 to 304 respectively, and ‘1’ is output when they match.

Therefore, if an input character matches a transition condition under the state determined to be active, the output of AND gates 400 to 403 becomes ‘1’, the register in the following step becomes active, and the state transition is performed.

Finally, when the register 204 that is the final state becomes active, the input string is judged to match the pattern of the regular expression “a(bc)*(d|e)”.

The NFA circuit has a configuration in which a register that represents each state and a comparator that judges whether transition conditions are input or not are connected according to the state transition of the NFA, since one character (1 byte) is processed per one clock cycle, search throughput performance is provided in proportion to an operating frequency.

Some methods have been proposed as well that improve search throughput by expanding the above method to increase the number of processing characters (the number of byte) per one clock cycle.

In the method shown in non-Patent Document 4, when performing a four-character (4 bytes) processing (the NFA performing processing with such a plurality of bytes will be referred to as “Multibyte NFA”, and the NFA whose processing byte number being k bytes will be referred to as “k-byte NFA”, hereinafter) for a one-character (1 byte) processing NFA against the “abcde” pattern shown in FIG. 26 (such a 1-byte processing NFA is referred to as a “1-byte NFA, hereinafter), four NFAs as shown in FIG. 27 are generated and they are made into a hardware circuit.

A white arrow in FIGS. 26 and 27 denotes an initial state, a state represented by a double circle denotes a final state, and a symbol ‘X’ denotes an arbitrary character.

As shown in FIGS. 26 and 27, with this method, the number of processing bytes per one clock cycle is increased by expanding the number of characters of the transition condition into plural and generating the NFAs in consideration of off-set positions where an object pattern starts.

Therefore, it is possible to discriminate in which position of the input string the pattern is matched by at which final state is arrived, however, since the NFAs as many as the number of processing bytes are necessary for one pattern, it is feared that the number of states increases.

Further, examples are given only to the case using an Exact Match, accordingly, a reduction in the number of states and correspondence to the regular expression are problems.

In the methods shown in non-Patent Document 5 and Patent Document 1, states having the same transition condition are shared in order to mitigate the increase in the number of the states, however, correspondence to the regular expression has been remained as a problem.

Contrary to these methods, in non-Patent Document 6, when expanding a 1-byte NFA for the regular expression pattern of “a(bc)*(d|e)” as shown in FIG. 24 to perform a four-character (4 bytes) processing, one NFA shown in FIG. 28 is generated to be made into a hardware circuit.

Similar to FIGS. 26 and 27, a white arrow denotes an initial state, a state denoted by a double circle denotes a final state, and a symbol ‘X’ denotes an arbitrary character.

With this method, it is possible to increase the number of processing bytes per one clock cycle without increasing the number of states by expanding the transition condition itself of the NFA generated by one regular expression pattern into plural bytes.

Therefore, it is expected that high-speed pattern match using the regular expression can be achieved, however, the NFA circuit alone cannot discriminate at which position of the input string the pattern matched, disadvantageously.

In Patent Document 2, a method has been proposed to improve search speed by the state transition of a plurality of character units and to reduce the preparation time of the state transition table by adopting a finite automaton method to a string search method of an information search system.

In addition, Patent Documents 3 to 6 have been proposed as a method to adopt the finite automaton method to string matching.

Patent Document 3 is a system that generates finite state automaton representing a context free grammar or finite state transducer from the context free grammar.

In Patent Document 4, finite state automaton checks each character in the input character string to decide whether the 2-byte expression is within an effective range, an effective check in a small memory is its objective.

In Patent Document 5, a method has been proposed in which character strings are searched while an automaton generation section generates a finite state automaton with a derivation type being the transition condition from a set of regular expressions and a search sound number region.

In Patent Document 6, it is disclosed that a document processing system is achieved by a computer that performs string search using DFA (Deterministic Finite Automaton) based on the search condition represented by the regular expression in the embodiment.

Non-Patent Document 1:

Yoshiyuki Kondo, “Algorithm and Data Structure for C-programmer”, SoftBank Creative, 1998, pp. 297-330

Non-Patent Document 2:

translated by Akihiro Nozaki, Masako Takahashi, Hajime Machida, and Hidenori Yamazaki, written by John E. Hoperoft, Rajeev Motowani, and Jeffrey D. Ullman, “Information & computing—3 Automaton Linguistic Theory Computation Theory I second edition”, Saiensu-sha, Co., Ltd., 2003, pp. 168-171

Non-Patent Document 3:

Reetinder Sidhu, Viktor K. Prasanna, Proceedings of the 9th Annual IEEE Symposium on Field-Programmable Custom Computing Machines, 2001, pp. 227-238.

Non-Patent Document 4:

Christopher R. Clark, David E. Schimmel, Proceedings of the 12th Annual IEEE Symposium on Field-Programmable Custom Computing Machines, 2004, pp. 249-257

Non-Patent Document 5:

Toshihiro Katashita, Atsushi Maeda, Masato Ono, Kenji Toda, Yoshinori Yamaguchi, Information Processing Society of Japan: Computing System, Vol. 46, No. SIG 12 (ACS 11), 2005, pp. 120-128

Non-Patent Document 6:

Norio Yamagaki, Satoshi Kamiya, Technical Report of Institute of Electronics, Information and Communication Engineers (Reconfigurable System), Vol. 107, No. 225, 2007, pp. 65-70

Patent Document 1:

Laid open Japanese Patent publication JP2007-142767A

Patent Document 2:

Japanese Patent Publication JP2745710B

Patent Document 3:

Laid open Japanese Patent publication JP 2004-004521A

Patent Document 4:

Laid open Japanese Patent publication JP06-028196A

Patent Document 5:

Laid open Japanese Patent publication JP 08-339378 A

Patent Document 6:

Japanese Patent Publication JP 3852757B

### DISCLOSURE OF THE INVENTION

### Problems to be Solved by the Invention

Problems for the above-described method are as follows that configures the NFA circuit from the Multibyte NFA where the number of characters in the state condition is expanded into plural.

A first problem is that in the NFA circuit configured by the Multibyte NFA where a transition condition itself of 1-byte NFA generated by a single regular expression pattern is expanded into plural bytes, when a pattern is matched, the NFA circuit alone cannot discriminate a position where the pattern is matched in the input character string. Further, in order to know it, a circuit is necessary for this purpose separately.

The reason is that since the transition condition is expanded into plural byte processing without increasing the number of states, the transition condition input to the final state is multiplexed and an off-set cannot be discriminated that defines at which position of the input character string the matching position falls. In order to know the matching position, an additional circuit becomes necessary that identifies the multiplexed transition condition.

A second problem is that in the NFA circuit configured from a plurality of Multibyte NFAs in consideration of the offset position where an objective pattern is started, it is possible to discriminate a position where the pattern is matched in the input character string based on by which final state has been reached. However, only the case using the exact match is exemplified, and no regular expression pattern is addressed including metacharacters having a special meaning.

The reason is that in order to configure the NFA in which the offset position is shifted, the pattern has to be uniquely decided. However, when a metacharacter is included such as ‘*’ that denotes a repetition of zero time or more, the pattern cannot be uniquely determined.

The purpose of the present invention is to provide a finite automaton circuit generation system for string matching for multi-byte processing that can discriminate alone a position where the pattern is matched in the input character string by making the transition condition itself of the NFA to expand into a plurality of bytes, a method of generating the same, a generation program, and a pattern matching device using the same.

Another purpose of the present invention is to provide a finite automaton circuit generation system for string matching for multi-byte processing addressed to a regular expression pattern, a method of generating the same, a generation program, and a pattern matching device using the same.

Still another purpose of the present invention is to provide a finite automaton circuit generation system for string matching for multi-byte processing that can generate the NFA circuit according to purposes by making it possible to select whether to generate the finite automaton circuit that can alone discriminate a position where the pattern is matched in the input character string, a method of generating the same, a generation program, and a pattern matching device using the same.

### Means to Solve the Problems

A finite automaton circuit generating system for a string matching for multibyte processing of the present invention has: a multibyte NFA conversion section (reference number 22 in FIG. 1, reference number 25 in FIG. 17) which converts a 1-byte NFA having no ε transition and converted from a regular expression into a Multibyte NFA which processes in designated number of bytes and which can discriminate a position where the pattern is matched in accordance with designated operation mode; an NFA storage section (reference number 32 in FIGS. 1 and 17) which stores those representing converted Multibyte NFA in a form of a certain data structure; and, an HDL (Hardware Description Language) conversion section (reference number 23 in FIGS. 1 and 17) which describes the Multibyte NFA as a hardware circuit while referring to a state of the converted Multibyte NFA and a state transition structure. The number of processing bytes for the Multibyte NFA to be converted can be designated in a value of power of two. Such configuration are adopted and, it enables to select, whether to convert it into the Multibyte NFA which can discriminate the position where the pattern is matched alone from the regular expression per se or to convert it into the Multibyte NFA which cannot discriminate that alone thereby, being possible to achieve first, second and third purposes of the present invention.

Moreover, a pattern matching apparatus using a fourth finite automaton circuit for a string matching for multibyte processing has, in addition to a first, a second finite automaton circuit generating system: configuration data conversion section (reference number 26 in FIG. 23) for generating Configuration data which is configuration information of a hardware device being capable of reconfiguration such as FPGA from the generated HDL; and a pattern matching section (reference number 122 in FIG. 23) configured on the hardware device which is capable of reconfiguration and capable of setting a configuration by the Configuration data. Such configuration are adopted and, a pattern matching is performed using a Multibyte NFA circuit which can discriminate the position where the pattern is matched alone from the regular expression per se or a Multibyte NFA circuit which cannot discriminate that alone thereby, being possible to achieve the first, second and third purposes of the present invention.

### Effect of the Invention

The first effect is to be able to discriminate a position where the pattern is matched in the input character string alone even in an NFA expanded into plural bytes from a transition condition per se of an NFA processing with 1-byte.

The reason is that when converting the NFA with 1 byte processing into the NFA with designated number of processing bytes, it makes a final state to increase in accordance with the processing bytes thereby, being possible to discriminate a position where the pattern is matched in the input character string by determining which final state the state reaches.

The second effect is to be able to select whether to generate the NFA which can discriminate a position where the pattern is matched in the input character string alone in accordance with the intended use. In a case that an NFA which cannot discriminate a position where the pattern is matched in the input character string alone is used, it is possible to generate a NFA circuit which can reduce a size of the circuit compared to the NFA circuit which can discriminate a position where the pattern is matched alone.

The reason is that in a case of actually performing a conversion, it is possible to designate either the NFA which can discriminate a position where the pattern is matched in the input character string alone or the NFA which cannot discriminate that alone as an operation mode. If the NFA which cannot discriminate a position where the pattern is matched is selected, it is different from a case of the NFA which can discriminate the a position where the pattern is matched, the final state is not increased in accordance with the processing bytes thereby, being possible to reduce the size corresponding to the number of states in the circuit.

The third effect is that the NFA which processes in plural bytes generated by the present invention can address to the regular expression.

The reason is that the regular expression per se is input and a conversion using it into the NFA which processes with plural bytes is performed.

The fourth effect is to be able to configure a high speed pattern matching device which addresses to the regular expression and can discriminate a position where the pattern is matched in the input character string alone.

The reason is that a pattern matching circuit is used configured from the HDL in which a hardware circuit of NFA having the first, second and third effects is described, further, this NFA circuit can process with plural bytes.

### BRIEF DESCRIPTION OF THE DRAWINGS

FIG. 1 is a block diagram showing a configuration of the first embodiment of the present invention.

FIG. 2 is a flow diagram showing operations of the first embodiment of the present invention.

FIG. 3 is a conventional example of data structure representing NFA of the first embodiment of the present invention.

FIG. 4 is a state transition diagram of data structure representing NFA of the first embodiment of the present invention.

FIG. 5 is a flow diagram showing step A6 in FIG. 2 of the first embodiment of the present invention.

FIG. 6 is a state transition diagram of an example (at the time of completing step B3) of halfway of performing 2-byte NFA conversion in which matching position is distinguishable using 1-byte NFA of FIG. 24 according to the flow diagram of FIG. 5 of the first embodiment of the present invention.

FIG. 7 is a state transition diagram of an example (at the time of selecting the state 0 and state 1 for the NFA of FIG. 6 as the state n and determining step B15) of halfway of performing 2-byte NFA conversion in which matching position is distinguishable using 1-byte NFA of FIG. 24 according to the flow diagram of FIG. 5 of the first embodiment of the present invention.

FIG. 8 is a state transition diagram of an example (at the time before starting step B16) of halfway of performing 2-byte NFA conversion in which matching position is distinguishable using 1-byte NFA of FIG. 24 according to the flow diagram of FIG. 5 of the first embodiment of the present invention.

FIG. 9 is a state transition diagram of an example of having performed 2-byte NFA conversion in which matching position is distinguishable using 1-byte NFA of FIG. 24 according to the flow diagram of FIG. 5 of the first embodiment of the present invention.

FIG. 10 is a state transition diagram of an example (at the time of completing step B3) of halfway of performing 4-byte NFA conversion in which matching position is distinguishable using 2-byte NFA of FIG. 9 according to the flow diagram of FIG. 5 of the first embodiment of the present invention.

FIG. 11 is a state transition diagram of an example of having performed 4-byte NFA conversion in which matching position is distinguishable using 2-byte NFA of FIG. 9 according to the flow diagram of FIG. 5 of the first embodiment of the present invention.

FIG. 12 is a state transition diagram of halfway (at the time of completing step B4) of performing 2-byte NFA conversion in which matching position is undistinguishable using 1-byte NFA of FIG. 24 according to the flow diagram of FIG. 5 of the first embodiment of the present invention.

FIG. 13 is a state transition diagram of halfway (at the time of selecting the state 0 and state 1 for the NFA of FIG. 12 as the state n and determining step B15) of performing 2-byte NFA conversion in which matching position is undistinguishable using 1-byte NFA of FIG. 24 according to the flow diagram of FIG. 5 of the first embodiment of the present invention.

FIG. 14 is a state transition diagram of halfway (at the time before starting step B16) of performing 2-byte NFA conversion in which matching position is undistinguishable using 1-byte NFA of FIG. 24 according to the flow diagram of FIG. 5 of the first embodiment of the present invention.

FIG. 15 is a state transition diagram of an example of having performed 2-byte NFA conversion in which matching position is undistinguishable using 1-byte NFA of FIG. 24 according to the flow diagram of FIG. 5 of the first embodiment of the present invention.

FIG. 16 is a state transition diagram of halfway (at the time of completing step B4) of performing 4-byte NFA conversion in which matching position is undistinguishable using 2-byte NFA of FIG. 15 according to the flow diagram of FIG. 5 of the first embodiment of the present invention.

FIG. 17 is a block diagram showing a configuration of the second embodiment of the present invention.

FIG. 18 is a flow diagram showing operations of the second embodiment of the present invention.

FIG. 19 is a state transition diagram of 1-byte NFA that is not generated in the 1-byte NFA conversion section 24 of the second embodiment of the present invention.

FIG. 20 is a state transition diagram of 1-byte NFA that is generated in the 1-byte NFA conversion section 24 of the second embodiment of the present invention.

FIG. 21 is a flow diagram showing step A10 of the second embodiment of the present invention.

FIG. 22 is a block diagram showing a configuration of the third embodiment of the present invention.

FIG. 23 is a block diagram showing a configuration of the fourth embodiment of the present invention.

FIG. 24 is a state transition diagram of NFA of 1-byte processing for the regular expression pattern of “a(bc)*(d|e)” using a conventional example.

FIG. 25 is a circuit diagram of NFA of 1-byte processing for the regular expression pattern of “a(bc)*(d|e)” using a conventional example.

FIG. 26 is a state transition diagram of NFA of 1-byte processing for the pattern of “abcde” using a conventional example.

FIG. 27 is a state transition diagram of NFA of 4-byte processing for the pattern of “abcde” using a conventional example.

FIG. 28 is a state transition diagram of NFA of 4-byte processing for the regular expression pattern of “a(bc)*(d|e)” using a conventional example.

### PREFERRED MODES FOR CARRYING OUT THE INVENTION

### First Embodiment of the Present Invention

Next, referring to the drawings, embodiments of the present invention will be described in detail.

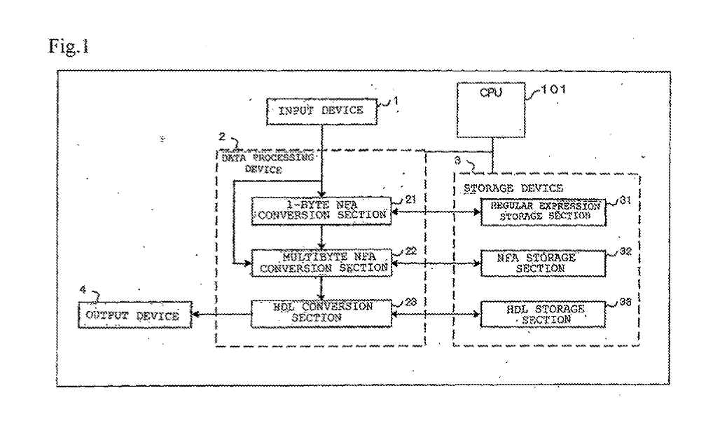

FIG. 1 is a block diagram showing the configuration of a first embodiment of the present invention.

Referring to FIG. 1, the first embodiment of the present invention includes an input device 1 such as a keyboard, a data processing device 2 that is operated under a program control, a storage device 3 for storing information, and an output device 4 such as a display device or a printer device.

The storage device 3 comprises a regular expression storage section 31, an NFA storage section 32 and an HDL storage section 33.

The regular expression storage section 31 stores one or more regular expressions input to a 1-byte NFA conversion section 21 from the input device.

The NFA storage section 32 stores the Multibyte NFA converted from the 1-byte NFA at a Multibyte NFA conversion section 22 in the form of data structure such as a list structure and matrix form.

The HDL storage section 33 stores HDL such as Verilog HDL and VHDL (Very Highspeed Integrated Circuit HDL) in which an NFA circuit of the Multibyte NFA stored in the NFA storage section 32 is described at an HDL conversion section 23.

The data processing device 2 comprises the 1-byte NFA conversion section 21, the Multibyte NFA conversion section 22 and the HDL conversion section 23.

The 1-byte NFA conversion section 21 reads out one regular expression or a list of plurality of regular expressions input from the input device 1 and causes the regular expression storage section 31 to store them.

The 1-byte NFA conversion section 21 converts the regular expression read out from the regular expression storage section 31 into the 1-byte NFA having no ε transition using, for example, a conventional technique such as that described in non-patent document 1, outputs a data structure representing generated NFA to the Multibyte NFA conversion section 22 and, starts a conversion of next regular expression.

When a conversion of the last regular expression stored in the regular expression storage section 31 is finished, the data structure representing the generated NFA and a signal indicating that all regular expressions are converted are output to the Multibyte NFA conversion section 22.

The Multibyte NFA conversion section 22 reads out an operating mode and the number of processing bytes input from the input device 1.

This number of processing bytes is the number of processing bytes of NFA and, the operation mode designates a type of Multibyte NFA to be generated.

It receives the data structure representing 1-byte NFA having no ε transition from the 1-byte NFA conversion section 21 and starts a conversion of them one by one into the Multibyte NFA which has a target number of bytes in accordance with the operation mode.

Upon finishing a conversion process for one NFA, the Multibyte NFA conversion section 22 cause the NFA storage section 32 to store the data structure representing converted Multibyte NFA, starts the conversion if the NFA received from the 1-byte NFA conversion section 21 is existed and, if the NFA is not existed, waits until next NFA is received.

Upon finishing the conversion of the NFA received with the signal indicating that all regular expressions are converted from the 1-byte NFA conversion section 21, it causes the NFA storage section 32 to store the converted NFA, reads out the data structure representing the NFA from the NFA storage section 32 and outputs it to the HDL conversion section 23.

When outputting the data structure of the last NFA, the signal indicating the last NFA is output therewith.

The HDL conversion section 23 analyzes information, such as a state of the NFA, transition between the states and a transition condition, from the data structure of the Multibyte NFA received from the Multibyte NFA conversion section 22, converts each state into registers and the transition condition into a string comparator, connects the registers each other according to the transition between the states and, converts it into HDL such as the Verilog HDL and the VHDL in which the circuit is described.

Moreover, the HDL conversion section 23 causes the HDL storage section 33 to store the converted HDL and, when finishing the conversion into the HDL, reads out the HDL from the HDL storage section 33 to output it the output device 4.

### Operation of the First Embodiment of the Present Invention

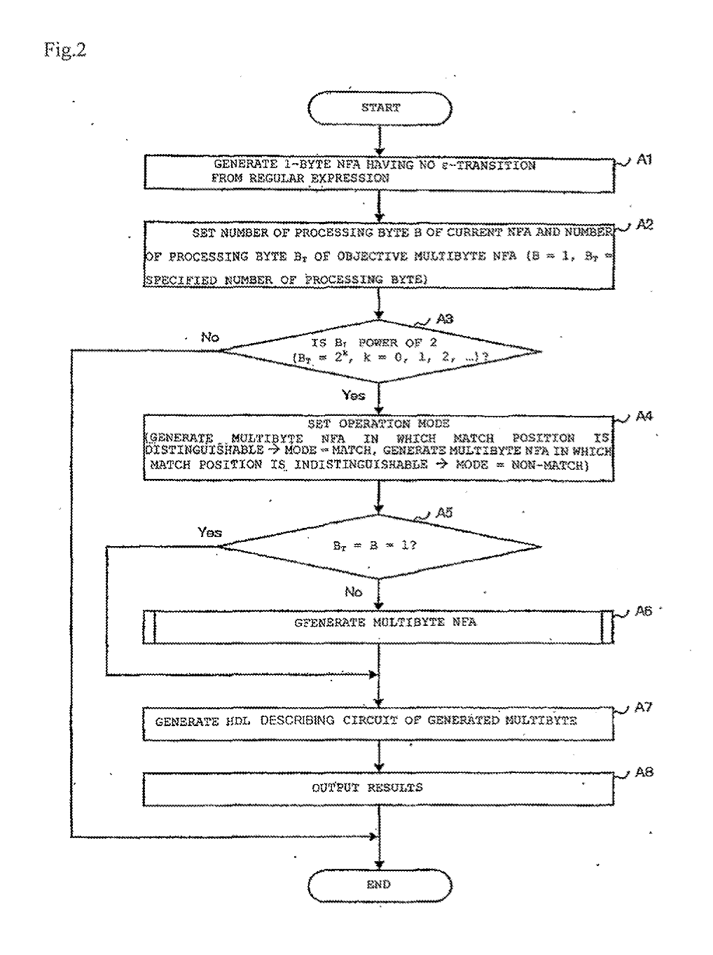

Next, referring to flowcharts shown in FIG. 1 and FIG. 2, the operation of the first embodiment of the present invention will be described in detail.

The regular expressions input from the input device 1 as one or a list of plural regular expressions are provided to the 1-byte NFA conversion section 21 and, the number of processing bytes of the NFA to be generated and an operation mode which designates a type of Multibyte NFA to be generated are provided to the Multibyte NFA conversion section 22.

The 1-byte NFA conversion section 21 causes the regular expression storage section 31 to store the received regular expressions, reads out the regular expression one by one and converts the regular expression into the 1-byte NFA having no ε transition using a known technique such as that described in non-patent document 1 (step A1).

When finishing the conversion, the 1-byte NFA conversion section 21 transmits the converted NFA to the Multibyte NFA conversion section 22, reads out next regular expression from the regular expression storage section 31 and starts the conversion into the 1-byte NFA having no ε transition.

When a conversion of the last regular expression stored in the regular expression storage section 31 is finished, the generated NFA and a signal indicating that all regular expressions are converted are output to the Multibyte NFA conversion section 22.

Here, the NFA sent by the 1-byte NFA conversion section 21 to the Multibyte NFA conversion section 22 is a data structure having state transition information of the NFA.

Usually, as described in the non-patent document 1 or the like, the state transition information needed for a case of focusing arbitrary state of the NFA is a state number of the transition destination and a label to be a transition condition.

The data structure which is capable of obtaining a state to transit next and a transition condition (label) of the transition should be enough as the output data structure, when focusing the arbitrary state.

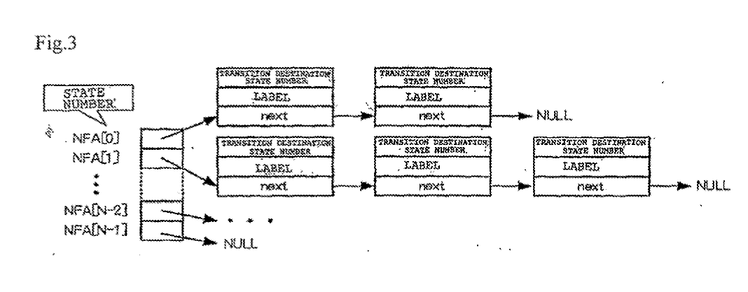

As the data structure representing such NFA, for example, there is a data structure using structure which is managed by a one-dimensional array and a linked list as shown in FIG. 3.

Considering the NFA having N states, the one-dimensional array NFA[i] (i=0, 1, . . . , N-1) specifies each state, the linked list of the transition information of which the start is an array element stores a transition destination state from the state i, character (string) (label) which is the transition condition and, a pointer to next transition information.

Although it will be described later, as the operation of the first embodiment of the present invention, when focusing an arbitrary state, it is needed for obtaining not only the transition destination state from the state and the transition condition of the transition but also the transition source state to transit to the focused state and the transition condition of the transition. Therefore, it is needed for checking all transition information to obtain the transition source state and the transition condition of the transition in the data structure shown in FIG. 3.

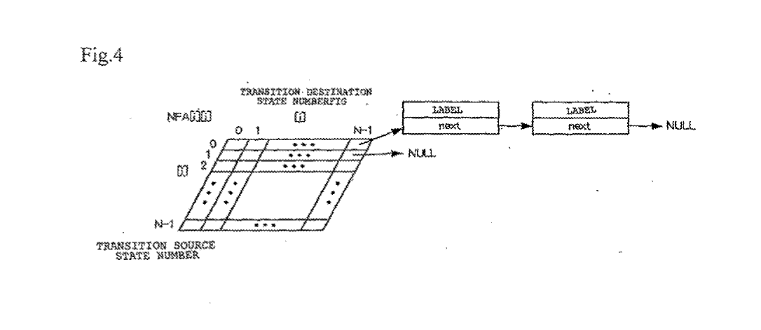

Consequently, as shown in FIG. 4 for example, it may be used a data structure in which two-dimensional array NFA[i] [j] (i, j=0, 1, . . . , N-1) specifies the transition from the state i to the state j, the linked list of the transition information of which the start is an array element stores the label which is the transition condition from the state i to the state j and, a pointer to next transition information.

Moreover, it can be expressed in a form of matrix, in which the number i of the row corresponds to the state number of transition source, the number j of the column corresponds to the state number of transition destination, the character of the transition condition form the state i to the state j is expressed in each element.

In this case, specific definitions are needed such as if there are a plurality of conditions from a state to another state, it is expressed by ‘+’ (for example, if the transition condition is characters ‘a’ and ‘b’, it represents “a+b”), and if there is no transition, it is expressed by 0.

The Multibyte NFA conversion section 22 sets the number of processing bytes B of the current NFA received from the 1-byte NFA conversion section 21 to 1 and, sets the number of processing bytes B_{T} of the objective Multibyte NFA to the number of processing bytes which is input from the input device 1 (step A2).

Here, the number of processing bytes of the objective Multibyte NFA, that is the number of bytes, which is input from the input device 1, can be specified only a value of power of 2 and, if it is other than that, the Multibyte NFA conversion section 22 performs an error handling and finishes the process (step A3).

Next, the Multibyte NFA conversion section 22 sets the operation mode which designates a type of Multibyte NFA to be generated and is input from the input device 1 (step A4).

The mode has two types: one is generating Multibyte NFA which can discriminate a position where the pattern is matched in the input character string alone (mode=match) and, the other is generating Multibyte NFA which cannot discriminate a position where the pattern is matched alone (mode=non-match).

When completing the setting described above, if the number of processing bytes B_{T} of the objective Multibyte NFA is not 1 byte (step A5), the Multibyte NFA conversion section 22 converts the 1-byte NFA having no ε transition and received from the 1-byte NFA conversion section 21 into the Multibyte NFA with the number of processing bytes B_{T} (step A6).

FIG. 5 is a flow diagram for explaining more detail operation of the step A6.

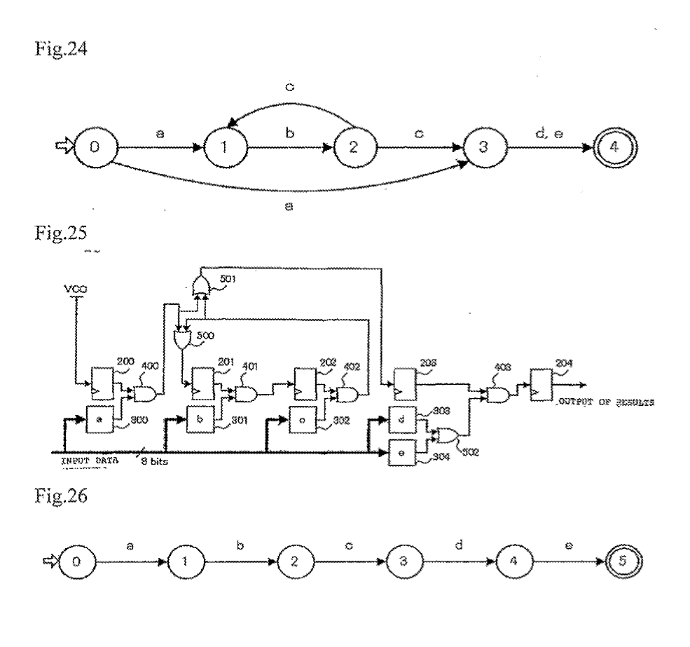

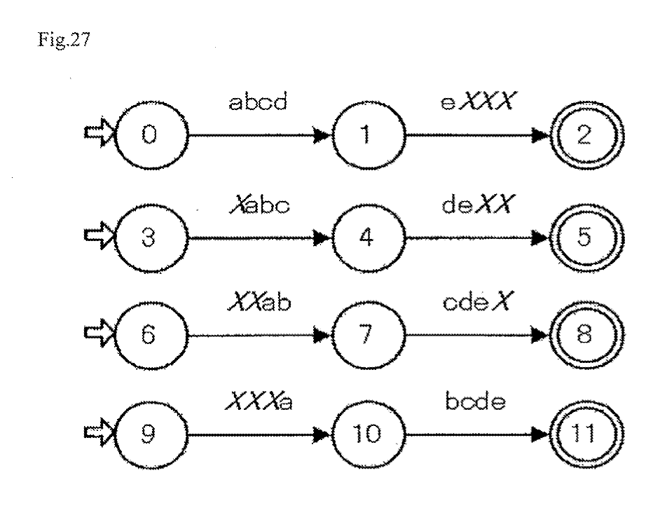

It will be explained with a conversion example of the 1-byte NFA having no ε transition which is generated from the regular expression “a(bc)*(d|e)” as shown in FIG. 24, as an example.

First, a transition from an initial state to the initial state by an arbitrary character is generated (step B1).

Here, a symbol indicating the arbitrary character is defined as X and, the generated transition is referred to as self-edge-initial.

Next, the operation mode is checked (step B2).

Hereinafter, it will be explained in a case of generating Multibyte NFA which can discriminate a position where the pattern is matched in the input character string alone (mode=match) as the operation mode.

In a case where the operation mode is “match”, the Multibyte NFA conversion section 22 generates one final state for each final state to generate transition by an arbitrary character (label ‘X’) from original final state to generated final state (step B3).

The transition generated in this step is referred to as edge-final.

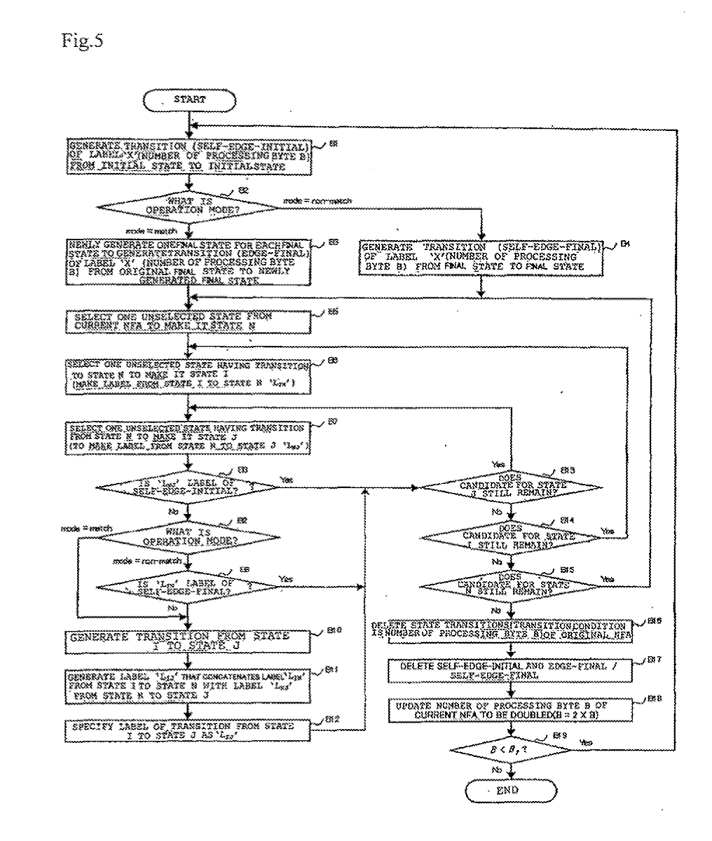

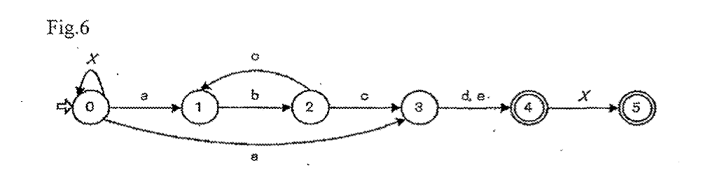

FIG. 6 shows an example of the NFA being completed by the step B3 for the NFA of FIG. 24.

Next, the Multibyte NFA conversion section 22 selects one state which has been unselected before from current NFA to make it a state n, selects one state which has been unselected before and has transition to the state n to make it a state i and, selects one state which has been unselected before and has transition from the state n to make it a state j (steps B5, B6, B7).

Here, it makes a label from the state i to the state n to ‘Lᵢₙ’ and makes a label from the state n to the state j to ‘Lₙⱼ’.

Subsequently, the Multibyte NFA conversion section 22 checks whether ‘Lₙⱼ’ is the label of self-edge-initial (step B8) and, in a case where it is the label of self-edge-initial, checks whether it remains a candidate for the state j which has been unselected (step B13).

The Multibyte NFA conversion section 22, in a case where it is not the label of self-edge-initial, checks the operation mode again (step B2).

In a case where the operation mode denotes “match”, the Multibyte NFA conversion section 22 generates a transition from the state i to the state j (step B10), generates a label ‘Lᵢⱼ’ that concatenates the label ‘Lᵢₙ’ from the state i to the state n and the label ‘Lₙⱼ’ from the state n to the state j (step B11) and, makes the label ‘Lᵢⱼ’ into a transition condition from the state i to the state j (step B12).

For example, in the NFA of FIG. 6, if the state 1, the state 0 and the state 2 are selected as the states n, i and j respectively, since the labels Lᵢₙ and Lₙⱼ become ‘a’ and ‘b’ respectively, it is generated a transition of a label “ab” from the state 0 to the state 2.

Here, the reason for checking whether ‘Lₙⱼ’ is the label of self-edge-initial at the step B8 is to prevent inserting an arbitrary character within the pattern such as a label “aX” in a case that Lᵢₙ and Lₙⱼ are ‘a’ and ‘X’, for example.

When finishing the process described above, the Multibyte NFA conversion section 22 checks whether it remains a candidate for the state j which has been unselected (step B13), repeats process from the step B7 if the candidate exists, checks, if the candidate does not exist, whether it remains a candidate for the state i which has been unselected (step B14).

Similarly, the Multibyte NFA conversion section 22 repeats process from the step B6 if the candidate for the state i exists, checks, if the candidate does not exist, whether it remains a candidate for the state n which has been unselected (step B15) and, repeats process from the step B5 if the candidate exists.

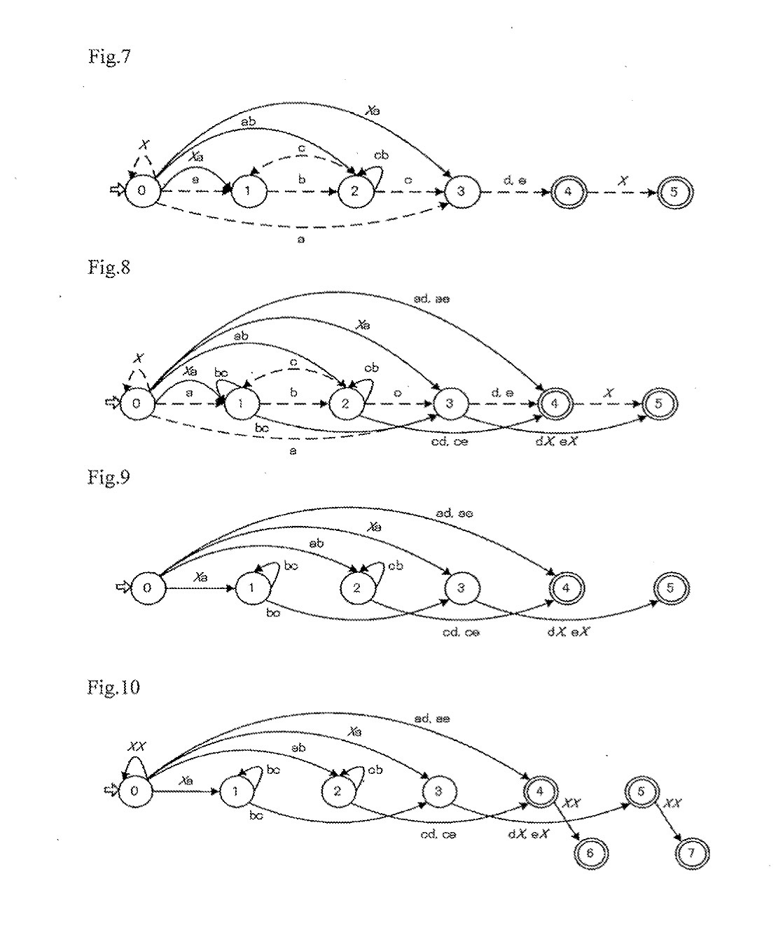

For example, in the NFA of FIG. 6, at the time of selecting the state 0 and the state 1 as the states n and checking the step B15, the NFA shown in FIG. 7 has been generated.

Here, the state transitions denoted by dashed lines are transitions of the original NFA (FIG. 24), a transition of self-edge-initial added in the step B1 and a transition of edge-final added in the step B3 and, the transitions denoted by solid lines represent transitions which are newly generated by this process.

After repeating the processes described above and when the candidate for the state n does not exist (step B15), the Multibyte NFA conversion section 22 deletes a state transition (of which transition condition is the number of processing bytes B) of the original NFA and transitions of self-edge-initial and edge-final added in the step B1 (step B16 and step B17) and, updates the number of processing bytes B of the current NFA to be doubled (step B18).

For example, the NFA right before starting the step B16 is shown in FIG. 8, the NFA right after performing the step B17 is shown in FIG. 9 and, it is generated a NFA which can discriminate a position where the pattern is matched in the input character string of which the number of processing bytes has been doubled from the original NFA.

Finally, the Multibyte NFA conversion section 22 compares the number of processing bytes B of converted NFA with B_{T} which denotes designated processing bytes, repeats the processes from the step B1 again if B is smaller than B_{T}, that is, it does not satisfy a objective number of processing bytes (step B19) and finishes the processes if it satisfies the objective number of processing bytes.

For example, as an example of NFA performed the processes from the step B1 again for FIG. 9, FIG. 10 shows the NFA right after completing the step B3 and FIG. 11 shows a conversion example of 4-byte NFA.

Further, it will be explained in a case of generating Multibyte NFA which cannot discriminate a position where the pattern is matched in the input character string alone (mode=non-match) as the operation mode.

In a case that the operation mode is “non-match”, it is performed basically similar processes of a case that the operation mode is “match”, however, it is different that the step B4 is performed instead of the step B3 and the step B9 is performed after the step B8.

Since the steps other than that are same as the steps in a case that the operation mode is “match”, the explanation is omitted hereinafter.

When selecting “non-match” as the operation mode, the Multibyte NFA conversion section 22 performs the step B1 and the step B2, after that, generates a transition of label ‘X’ from a final state to the final state, which is referred to as self-edge-final (step B4).

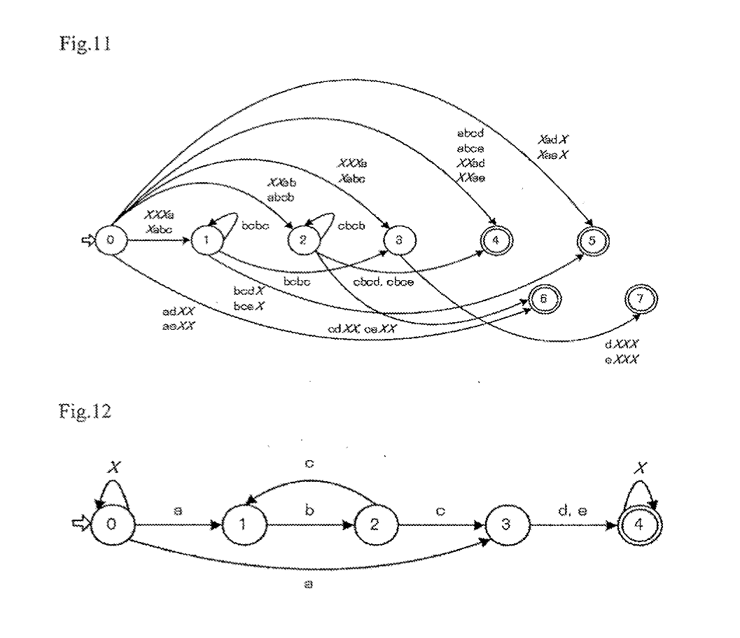

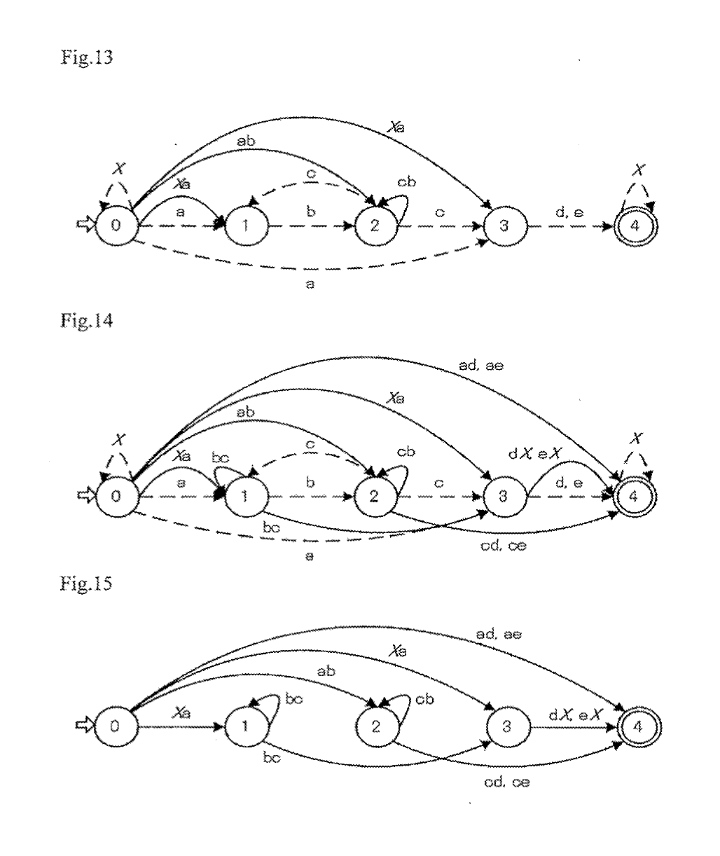

Similar to a case that the operation mode is “match”, explaining with the conversion example of the 1-byte NFA having no ε transition which is generated from the regular expression “a(bc)*(d|e)” as shown in FIG. 24, an example of NFA completed by the step B4 becomes that shown in FIG. 12.

Subsequently, the Multibyte NFA conversion section 22 performs the processes from the step B5 to the step B8 and, if the label ‘Lₙⱼ’ is a label of self-edge-initial, checks whether it remains a candidate for the state j which has been unselected (step B13).

If it is not a label of self-edge-initial, the Multibyte NFA conversion section 22 checks the operation mode (step B2), after that, checks whether the label ‘Lᵢₙ’ is a label of self-edge-final (step B9) and, proceeds the step B13 if it is a label of self-edge-final, proceeds the step B10 if it is not a label of self-edge-final and continues the process.

Here, the reason for checking whether ‘Lᵢₙ’ is the label of self-edge-final at the step B9 is to prevent inserting an arbitrary character within the pattern such as a label “Xa” in a case that Lᵢₙ and Lₙⱼ are ‘X’ and ‘a’, for example.

For example, in the NFA of FIG. 12, at the time of selecting the state 0 and the state 1 as the states n and checking the step B15, the NFA becomes as shown in FIG. 13.

Here, the state transitions denoted by dashed lines are transitions of the original NFA (FIG. 24) and transitions of self-edge-initial and self-edge-final added in the step B1 and the step B4 and, the transitions denoted by solid lines represent transitions which are newly generated by this process.

As a result of further proceeding the steps, the NFA right before the step B16 becomes as shown in FIG. 14, the NFA right after the step B17 becomes as shown in FIG. 15 and, it is generated a NFA which cannot discriminate a position where the pattern is matched in the input character string of which the number of processing bytes has been doubled from the original NFA.

Finally, the step B19 is performed and, it finishes the processes if it satisfies the objective number of processing bytes.

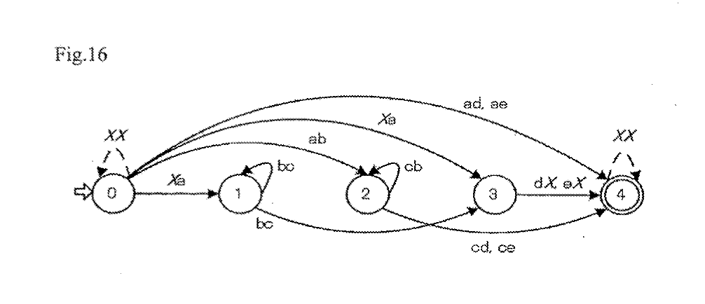

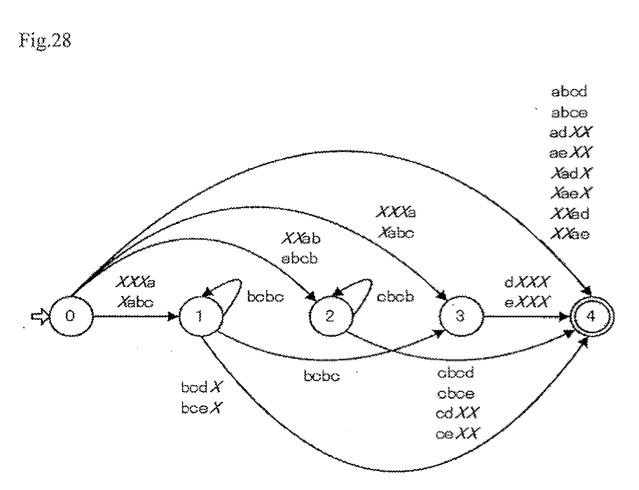

For example, in a case of performing the processes from the step B1 again for FIG. 15, the NFA becomes as shown in FIG. 16 right after the step B4 and, finally, the 4-byte NFA shown in FIG. 28 is generated.

Upon completing the step A6, the Multibyte NFA conversion section 22 cause the NFA storage section 32 to store the generated Multibyte NFA, starts the conversion if the NFA received from the 1-byte NFA conversion section 21 is existed and, if the NFA is not received, waits until next NFA is received.

Upon finishing the conversion of the NFA received with the signal indicating that all regular expressions are converted from the 1-byte NFA conversion section 21, it causes the NFA storage section 32 to store the converted NFA, after that, reads out the data structure representing the NFA from the NFA storage section 32 and outputs it to the HDL conversion section 23.

The Multibyte NFA conversion section 22, when outputting the data structure of the last NFA, outputs the signal indicating the last NFA therewith (step A6).

The HDL conversion section 23 analyzes information, such as states of each NFA, transition between the states and a transition condition, from the data structure of the Multibyte NFA received from the Multibyte NFA conversion section 22, converts each of the states into registers and the transition condition into a string comparator, connects the registers each other according to the transition between the states, converts it into HDL such as the Verilog HDL and the VHDL in which the circuit is described and, cause the HDL storage section 33 to store the converted HDL (step A7).

Upon finishing the conversion into the HDL, the HDL conversion section 23 reads out the generated HDL from the HDL storage section 33 if required and, outputs it to the output device 4 (step A8).

Next, an operation and effect of the first embodiment of the present invention will be described.

In the first embodiment of the present invention, by inputting a regular expression per se, it is possible to perform a conversion from the 1-byte NFA to the Multibyte NFA for transiting with designated number of processing bytes and, to generate HDL in which the NFA circuit is described.

Moreover, the Multibyte NFA generated in the embodiment is addressed to not only Exact Match but also the regular expression per se, further, it is possible to generate an NFA circuit using the Multibyte NFA which can discriminate a position where the pattern is matched in the input character string alone by designating the operation mode.

As described above, according to the NFA circuit among the conventional NFA circuit performing a processing with plural bytes, the NFA circuit being configured by the Multibyte NFA where a transition condition itself of the 1-byte NFA generated from a single regular expression pattern is expanded into plural bytes, there is a problem that, when a pattern is matched, the NFA circuit alone cannot discriminate a position where the pattern is matched in the input character string. According to the present invention, it is possible to discriminate a position where the pattern is matched in the input character string, by newly generating final states in accordance with the number of processing bytes and determining which final state among these final states the state reaches.

For example, for the regular expression “a(bc)*(d|e)”, if it has generated the 4-byte NFA which can discriminate a position where the pattern is matched in the input character string, the NFA as shown in FIG. 11 is generated.

In a case of using such NFA, when it reaches the state 4 and is matched, it can determine that it is matched at last character among the 4 characters (4 bytes) which is input at that time and, in a case of the state 5, it can determine that it is matched at third character from the head of the string.

That is, it is possible to determine a position where the pattern is matched in the input character string by the NFA circuit alone in accordance with which final state among the final states 4, 5, 6 and 7 the state reaches.

If it is not necessary to know a position where the pattern is matched in the input character string and it is necessary to know only whether or not it is matched for a certain regular expression, it is possible to generate a conventional Multibyte NFA circuit which cannot discriminate a position where the pattern is matched in the input character string alone by designating the operation mode. In this case, since the final states are not increased in accordance with the number of processing bytes, the number of the state remains the same as the number of the state of the original 1-byte NFA and it is possible to reduce a size of the circuit compared to the NFA with same number of processing bytes which can discriminate a position where the pattern is matched alone.

According to the above-described embodiment, the 1-byte NFA having no ε transition and converted by the 1-byte NFA conversion section 21 is sent to the Multibyte NFA conversion section 22 every finishing the conversion but, it may store that to the NFA storage section 32 directly, outputs only a signal which denotes a conversion of the 1-byte NFA having no ε transition is completed to the Multibyte NFA conversion section 22 and, the Multibyte NFA conversion section 22 may perform a conversion into the NFA while reading out the 1-byte NFA having no ε transition and stored in the NFA storage section 32.

The Multibyte NFA conversion section 22, after causing the NFA storage section 32 to store the converted Multibyte NFA and finishing the conversion for all regular expressions, reads out all Multibyte NFAs from the NFA storage section 32 and outputs them to the HDL conversion section 23 but, the Multibyte NFA conversion section 22 may notify the HDL conversion section 23 of finishing the conversion and the HDL conversion section 23 may perform the HDL conversion process while reading out the Multibyte NFA from the NFA storage section 32.

Furthermore, the Multibyte NFA conversion section 22 may outputs it to the HDL conversion section 23 instead of causing the NFA storage section 32 to store it every finishing conversion and the HDL conversion section 23 may start the HDL conversion process.

Thus, by comprising the regular expression storage section 31, the NFA storage section 32 and the HDL storage section 33, the input device 1 can input a new regular expression without waiting for finishing the process of the 1-byte NFA conversion section 21. Then the 1-byte NFA conversion section 21 can start the conversion process of next 1-byte NFA without waiting for finishing the process of the Multibyte NFA conversion section 22, if a new regular expression data is existed in the regular expression storage section 31.

Similarly, in a case that the 1-byte NFA having no ε transition and converted by the 1-byte NFA conversion section 21 is stored in the NFA storage section 32 directly, the Multibyte NFA conversion section 22 can start the conversion process of next Multibyte NFA if a new 1-byte NFA having no ε transition is existed in the NFA storage section 32.

In a case that the HDL conversion section 23 can read out the Multibyte NFA from the NFA storage section 32 directly, it is possible to start the HDL conversion process if a new Multibyte NFA is existed in the NFA storage section 32.

Thus, by using the storage device 3, it is possible to perform a HDL generating process effectively in which an effective NFA circuit is described.

Furthermore, by removing the HDL conversion section 23 and the HDL storage section 33 from the above-described embodiment and outputting a data structure of the generated Multibyte NFA from the Multibyte NFA conversion section 22 to the output device 4 directly, it is possible to generate a finite automaton for string matching for multi-byte processing, not for the NFA circuit.

Moreover, in the present invention, if it applies a configuration same as this embodiment and generates a DFA which processes with 1 byte at the 1-byte NFA conversion section 21, it is possible to apply not only NFA but also DFA and to generate the DFA of plural bytes to processing, which can discriminate a position where the pattern is matched in the input character string.

### Second Embodiment of the Present Invention

Next, referring to the drawings, a second embodiment of the present invention will be described in detail.

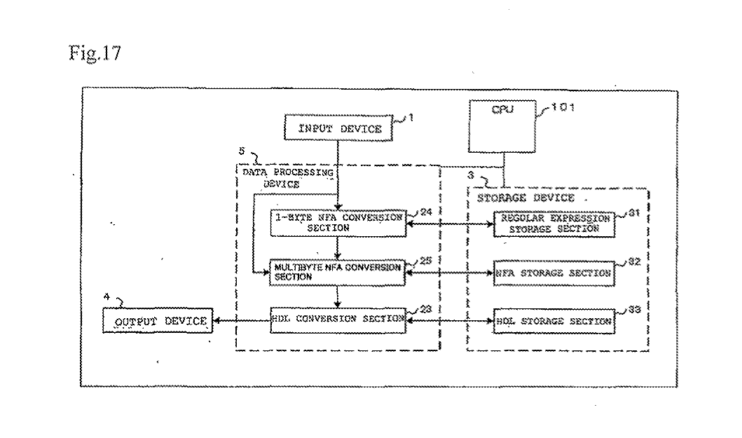

FIG. 17 is a block diagram showing the configuration of the second embodiment of the present invention.

Referring to FIG. 17, in the second embodiment of the present invention, the data processing device 5 comprises a 1-byte NFA conversion section 24, a Multibyte NFA conversion section 25 and the HDL conversion section 23.

This embodiment replaces the 1-byte NFA conversion section 21 and the Multibyte NFA conversion section 22 of the data processing device 2 in the above-described first embodiment shown in FIG. 1, to the 1-byte NFA conversion section 24 and the Multibyte NFA conversion section 25.

The others are same as those of the above-described first embodiment.

The 1-byte NFA conversion section 24 generates a 1-byte NFA having no ε transition from a regular expression as with the 1-byte NFA conversion section 21 in the above-described first embodiment but, adds a limitation to the NFA.

The others are same as the 1-byte NFA conversion section 21 in the above-described first embodiment.

The Multibyte NFA conversion section 25 performs a Multibyte NFA conversion in a specialized procedure for the 1-byte NFA which has a limitation condition generated by the 1-byte NFA conversion section 24. The others are same as the Multibyte NFA conversion section 22 in the above-described first embodiment.

### Operation of the Second Embodiment of the Present Invention

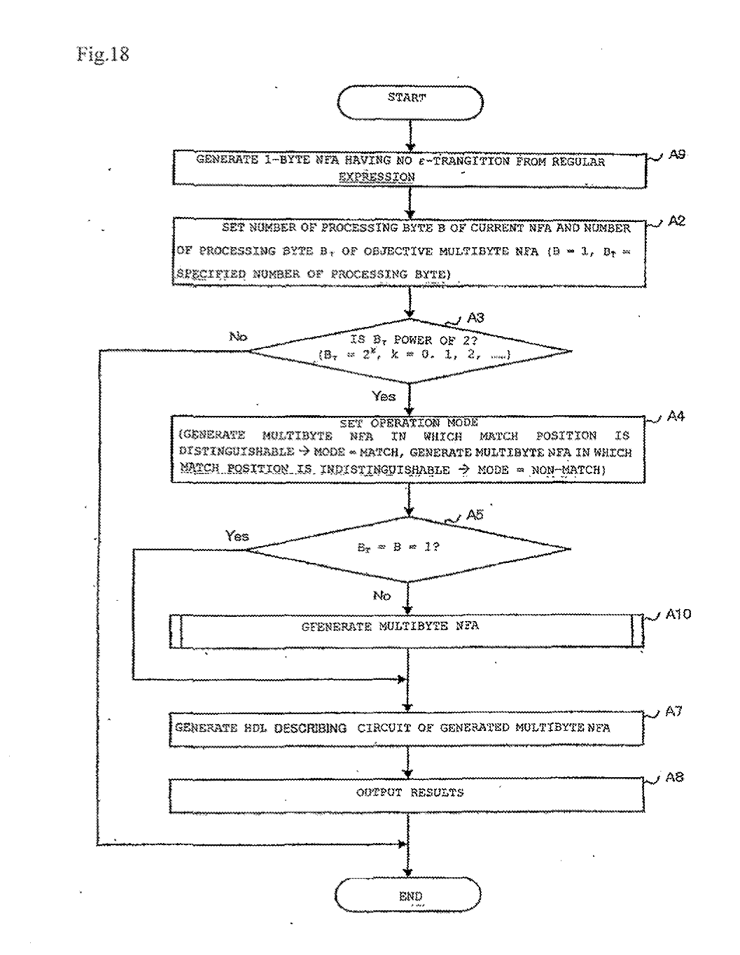

Next, referring to FIG. 17 and FIG. 18, the operation of the second embodiment of the present invention will be described in detail.

The regular expressions input from the input device 1 as one or a list are provided to the 1-byte NFA conversion section 24 and, the number of processing bytes of the Multibyte NFA to be generated and the operation mode which specifies a type of the Multibyte NFA to be generated are provided to the Multibyte NFA conversion section 25.

The 1-byte NFA conversion section 24 causes the regular expression storage section 31 to store the received regular expression, reads out the regular expression one by one, and converts the regular expression into the 1-byte NFA having no ε transition and added a certain limitation condition while using a known technique disclosed in the non-patent document 1 and the like (step A9).

Here, it will be described on the limitation condition of the 1-byte NFA having no ε transition generated by the 1-byte NFA conversion section 24.

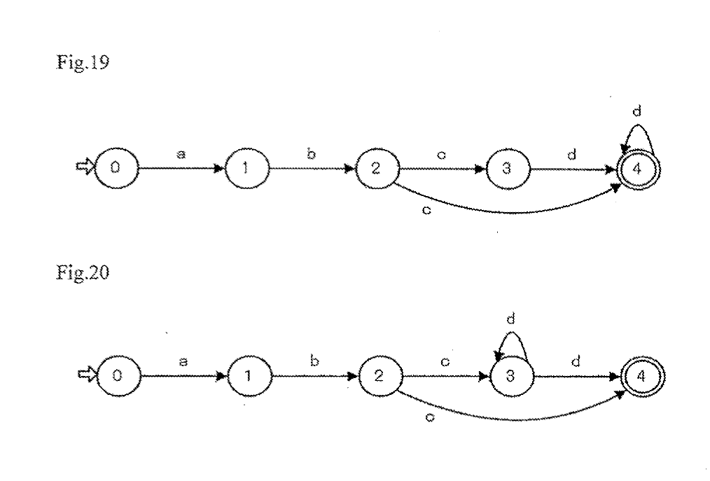

For example, considering a regular expression “abcd*”, examples of the 1-byte NFA having no ε transition for this regular expression are shown in both of FIG. 19 and FIG. 20.

A difference between these NFAs is one NFA is that in which a transition from a final state to other state including own state is existed (here, indicating a transition of a label ‘d’ from a state 4 to the state 4) (FIG. 19) and another NFA is that in which a transition from a final state to other state including own state is not existed (FIG. 20).

The 1-byte NFA conversion section 21 in the above-described first embodiment may generate any one of these NFAs and it is possible to convert the objective Multibyte NFA for both of these NFAs in the above-described first embodiment. However, in the 1-byte NFA conversion section 24, it is added the limitation condition which denotes to generate NFA in which a transition from a final state to other state including own state is not existed as shown in FIG. 20 thereby, being not possible to convert the objective Multibyte NFA unless the 1-byte NFA added such limitation condition, in the second embodiment.

As described below, adding this limitation brings a merit that it is possible to simplify in part of the conversion process in the Multibyte NFA conversion section 25.

Since the operation of the 1-byte NFA conversion section 24 other than that, including the data structure of the converted NFA or the like, is all same as the operation of the above-described first embodiment, the detail explanation will be omitted.

Next, the Multibyte NFA conversion section 25 performs processes from the step A2 to the step A4 and, if the number of processing bytes B_{T} of the objective Multibyte NFA is not equal to 1 byte (step A5), the Multibyte NFA conversion section 25 converts the 1-byte NFA having no ε transition and received from the 1-byte NFA conversion section 24 into the Multibyte NFA of the number of processing bytes B_{T} (step A10).

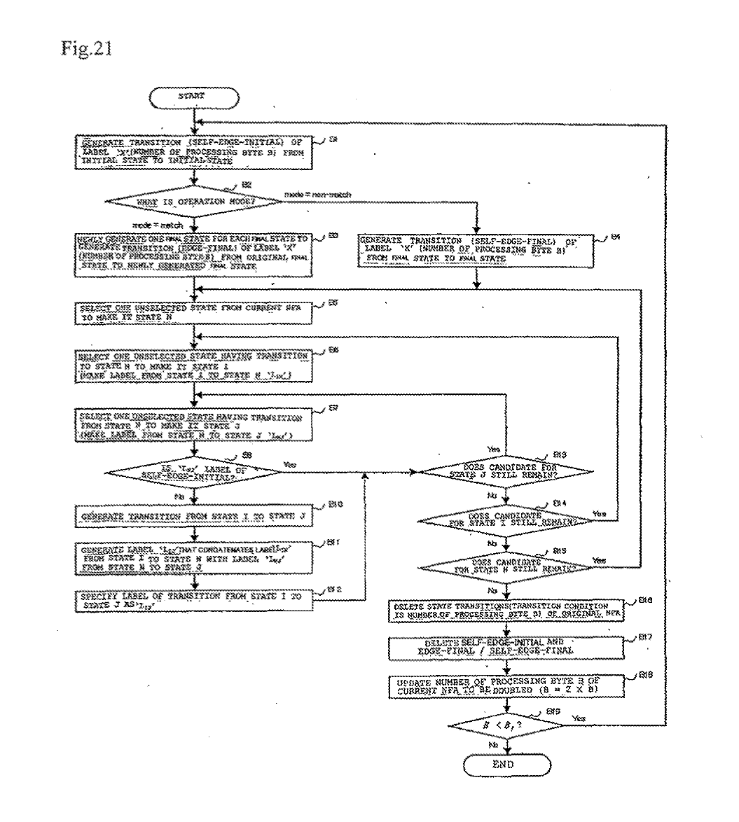

Since the steps from the step A2 to the step A5 are same as the operation of the above-described first embodiment, the detail explanation will be omitted. FIG. 21 is a flow diagram for explaining more detail operation of the step A10.

Since each of the steps from the step B1 to the step B8 and from the step B10 to the step B19 are same as the operation of the above-described first embodiment, the detail explanation will be omitted. But, as the step A10 (FIG. 21), the Multibyte NFA conversion section 25 selects the state n, the state i and the state j (steps B5, B6, B7), after that, checks whether the label ‘Lₙⱼ’ is the label of self-edge-initial (step B8) and, if it is not the label of self-edge-initial, performs the step B10 immediately in which a transition from the state i to the state j is generated. These are different from the step A6 (FIG. 5) in the above-described first embodiment.

With respect to the operation (step A7 and step A8) after finishing the step A10 in the Multibyte NFA conversion section 25, since the operation is same as the operation after finishing the step A6 of the above-described first embodiment, the detail explanation will be omitted.

Next, an operation and effect of the second embodiment of the present invention will be described.

In the second embodiment of the present invention, similar to the above-described first embodiment, by inputting a regular expression per se, it is possible to perform a conversion from the 1-byte NFA to the Multibyte NFA for transiting with designated number of processing bytes and, to generate the HDL in which the NFA circuit is described.

Moreover, the Multibyte NFA generated in this embodiment is addressed to not only Exact Match but also the regular expression per se, further, it is possible to generate an NFA circuit using the Multibyte NFA which can discriminate a position where the pattern is matched in the input character string alone by designating the operation mode.

In particular, there is an ingenuity that it is possible to simplify in part of following conversion to the Multibyte NFA by adding the limitation condition at the time of the conversion from the regular expression to the 1-byte NFA having no ε transition.

Specifically, in the above-described first embodiment, it performs the step B2 after the step B8 as shown in FIG. 5, further performs the step B9 according to the operation mode, after that, performs the step B10. However, in this second embodiment, as shown in FIG. 21, the Multibyte NFA conversion section 25 can perform the step B10 immediately if the label is not the label of self-edge-initial at the step B8.

Moreover, similar to the first embodiments, by designating the operation mode, it is possible to generate both of the NFA circuit which can discriminate a position where the pattern is matched in the input character string alone and the NFA circuit which cannot discriminate a position where the pattern is matched in the input character string alone and, to generate effective NFA circuit in accordance with the intended use.

According to the above-described embodiment, similar to the first embodiment, the 1-byte NFA having no a transition and converted by the 1-byte NFA conversion section 24 is sent to the Multibyte NFA conversion section 25 every finishing the conversion but, it may store that to the NFA storage section 32 directly, outputs only a signal which denotes a conversion of the 1-byte NFA having no a transition is completed to the Multibyte NFA conversion section 25 and, the Multibyte NFA conversion section 25 may perform a conversion into the Multibyte NFA while reading out the 1-byte NFA having no a transition and stored in the NFA storage section 32.

The Multibyte NFA conversion section 25, after causing the NFA storage section 32 to store the converted Multibyte NFA and finishing the conversion for all regular expressions, reads out all Multibyte NFAs from the NFA storage section 32 and outputs them to the HDL conversion section 23 but, the Multibyte NFA conversion section 25 may notify the HDL conversion section 23 of finishing the conversion and the HDL conversion section 23 may performs the HDL conversion process while reading out the Multibyte NFA from the NFA storage section 32.

Furthermore, the Multibyte NFA conversion section 25 may outputs it to the HDL conversion section 23 instead of causing the NFA storage section 32 to store it every finishing conversion and the HDL conversion section 23 may start the HDL conversion process.

Thus, by comprising the regular expression storage section 31, the NFA storage section 32 and the HDL storage section 33, the input device 1 can input a new regular expression without waiting for finishing the process of the 1-byte NFA conversion section 24.

Then the 1-byte NFA conversion section 24 can start the conversion process of next 1-byte NFA without waiting for finishing the process of the Multibyte NFA conversion section 25, if a new regular expression data is existed in the regular expression storage section 31.

Similarly, in a case that the 1-byte NFA having no ε transition and converted by the 1-byte NFA conversion section 24 is stored in the NFA storage section 32 directly, the Multibyte NFA conversion section 25 can start the conversion process of next Multibyte NFA if a new 1-byte NFA having no ε transition is existed in the NFA storage section 32. In a case that the HDL conversion section 23 can read out the Multibyte NFA from the NFA storage section 32 directly, it is possible to start the HDL conversion process if a new Multibyte NFA is existed in the NFA storage section 32.

Thus, by using the storage device 3, it is possible to perform a HDL generating process effectively in which an NFA circuit is described.

Furthermore, by removing the HDL conversion section 23 and the HDL storage section 33 from the above-described embodiment and outputting a data structure of the generated Multibyte NFA from the Multibyte NFA conversion section 25 to the output device 4 directly, it is possible to generate a finite automaton for string matching for multi-byte processing, not for the NFA circuit.

Moreover, in the present invention, if it applies a configuration same as this embodiment and generates a DFA which processes with 1 byte at the 1-byte NFA conversion section 24, it is possible to apply not only NFA but also DFA and to generate the DFA of plural bytes processing, which can discriminate a position where the pattern is matched in the input character string.

### Third Embodiment of the Present Invention

Next, referring to the drawings, a third embodiment of the present invention will be described in detail.

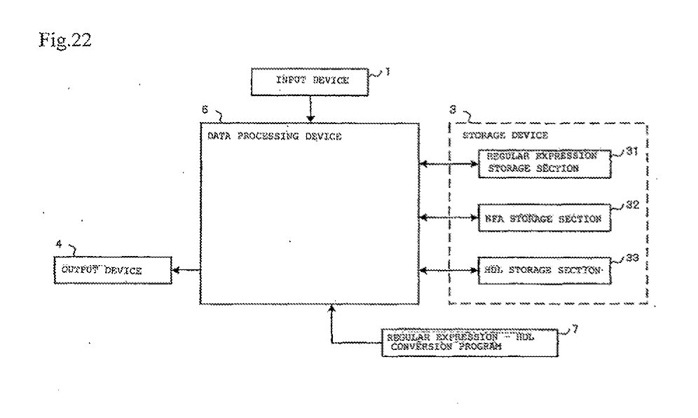

FIG. 22 is a block diagram showing the configuration of the third embodiment of the present invention.

Referring to FIG. 22, the third embodiment of the present invention, similar to the above-described first and second embodiments, comprises the input device 1, a data processing device 6, the storage device 3 and the output device 4.

In this embodiment, the processes in the 1-byte NFA conversion section 21, the Multibyte NFA conversion section 22 and the HDL conversion section 23 of the data processing device 2 in the above-described first embodiment, or in the 1-byte NFA conversion section 24, the Multibyte NFA conversion section 25 and the HDL conversion section 23 of the data processing device 5 in the above-described second embodiment are implemented by a regular expression—HDL conversion program 7 executed on the data processing device.

The regular expression—HDL conversion program 7 is loaded on the data processing device 6, controls the operation of the data processing device 6 and generates the regular expression storage section 31, the NFA storage section 32 and the HDL storage section 33 in the storage device 3.

The data processing device 6 executes processes identical to the processes of the data processing device 2 and 5 in the first and second embodiments under a control of the regular expression—HDL conversion program.

Next, an operation and effect of the third embodiment of the present invention will be described.

In the third embodiment of the present invention, similar to operation and effect in the first and second embodiments, by inputting a regular expression per se, it is possible to generate HDL in which the NFA circuit for achieving Multibyte NFA for transiting with designated number of processing bytes is described.

Moreover, the Multibyte NFA generated in the embodiment is addressed to not only Exact Match but also the regular expression per se, further, it is possible to generate an NFA circuit using the Multibyte NFA which can discriminate a position where the pattern is matched in the input character string alone by designating the operation mode.

Moreover, by designating the operation mode, it is possible to generate both of the NFA circuit which can discriminate a position where the pattern is matched in the input character string alone and the NFA circuit which cannot discriminate a position where the pattern is matched in the input character string alone and, to generate effective NFA circuit by selecting in accordance with the intended use.

Further, the regular expression—HDL conversion program 7 is loaded on the data processing device 6, controls the operation of the data processing device 6 and generates only the regular expression storage section 31 and the NFA storage section 32 in the storage device 3, the data processing device 6 outputs the data structure of the Multibyte NFA to the output device 4 thereby, being possible to a finite automaton for a string matching for multibyte processing not for an NFA circuit.

In the third embodiment of the present invention, similar to the first and second embodiments, it is possible to perform similar process not only to NFA but also to DFA.

### Fourth Embodiment of the Present Invention

Next, referring to the drawings, a fourth embodiment of the present invention will be described in detail.

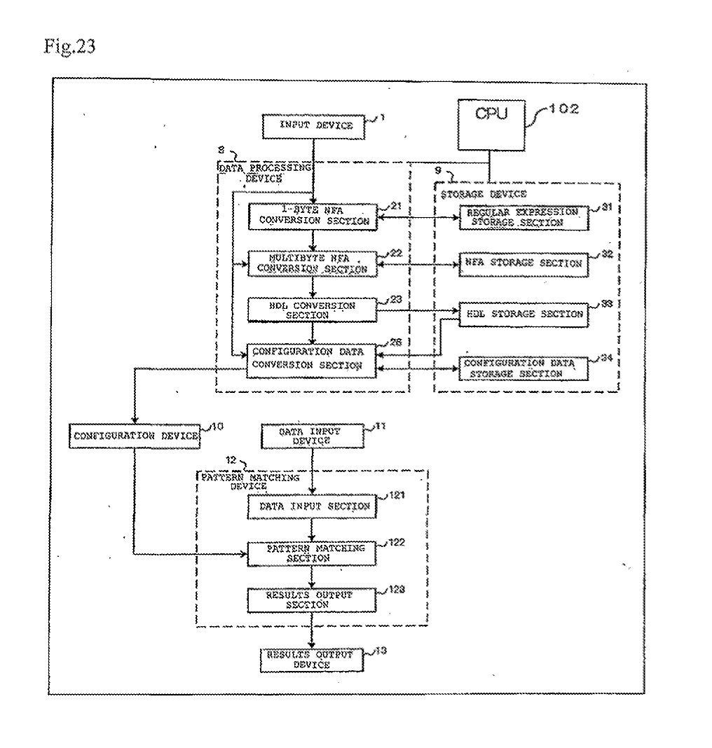

FIG. 23 is a block diagram showing the configuration of the fourth embodiment of the present invention.

Referring to FIG. 23, the fourth embodiment of the present invention comprises the input device 1 such as a keyboard, a data processing device 8 operating under a program control, a storage device 9 storing information, a configuration device 10 such as a cable making, on a hardware device capable of reconfiguration such as FPGA, a configuration thereof, a data input device 11 for inputting a search target data of a pattern matching into a pattern matching device, a pattern matching device 12 having a hardware device capable of reconfiguration such as FPGA and, a results output device 13 for outputting a result of the pattern matching such as a display device and a printer device.

Furthermore, a unit for controlling the data processing device 8 and the storage device 9 is a CPU 102, the CPU 102 operates according to programs in each section in the data processing device 8.

The pattern matching device 12 is configured by the hardware device capable of reconfiguration such as FPGA.

In the storage device 9, a Configuration data storage section 34 is added to the storage device 3 of the above-described first embodiment shown in FIG. 1.

The others are similar to that of the above-described first embodiment.

The Configuration data storage section 34 stores Configuration data which is configuration information of a target device and generated in the Configuration data conversion section 26 from HDL in which the Multibyte NFA circuit read out from the HDL storage section 33 is described.

In the data processing device 8, the Configuration data conversion section 26 is added to the data processing device 2 of the above-described first embodiment shown in FIG. 1.

The others are similar to that of the above-described first embodiment.

The Configuration data conversion section 26, when receiving a signal indicating that a conversion into the HDL at the HDL conversion section 23 is completed or, a signal indicating a generation start of the Configuration data from the input device 1, reads out the HDL in which the Multibyte NFA circuit stored in the HDL storage section 33 designated by each signal is described and, converts the HDL into the Configuration data which is configuration information of a target device. After the conversion, the Configuration data conversion section 26 stores it to the Configuration data storage section 34.

With respect to the conversion from the HDL into the Configuration data, development tool or the like provided by a vendor is used if it is FPGA, here, the detail explanation will be omitted.

The pattern matching device 12 comprises a data input section 121, a pattern matching section 122 and a results output section 123 which are configured on individual hardware devices each of which are capable of reconfiguration.

The data input section 121 shapes packet data input from the data input device 11 or pattern matching objective data (refer to as data to be searched) such as text data, parallelizes them by the number of processing bytes generated by the data processing device 8 and inputs them to the pattern matching section 122.

The pattern matching section 122 is a circuit configured by the Configuration data which is generated by the data processing device 8 and input via the configuration device 10.

The pattern matching section 122 is also the Multibyte NFA per se which is generated by the data processing device 8. In the NFA circuit configured on the pattern matching section 122, a state transition is occurred according to data to be searched which is input from the data input section 121, when matching with the pattern, an output signal is output from a register configuring a final state to the results output section 123.

The results output section 123 receives a signal indicating that it has been matched with input pattern from the pattern matching section 122.

If the NFA circuit configured on the pattern matching section 122 is the NFA circuit which can discriminate a position where the pattern is matched in the input character string, it processes information indicating in which position and which pattern it is matched in the input data to be searched in accordance with from which state the signal is received and, if the NFA circuit configured on the pattern matching section 122 is the NFA circuit which cannot discriminate a position where the pattern is matched in the input character string, it processes information indicating in which input character string and which pattern the input data to be searched is matched and, outputs it to the results output device 13.

There is a technique to notify the information indicating which pattern it is matched by a predetermined pattern number or the like.

Next, an operation and effect of the fourth embodiment of the present invention will be described.

In the fourth embodiment of the present invention, by inputting a regular expression per se, it is possible to perform a conversion from the 1-byte NFA to the Multibyte NFA for transiting with designated number of processing bytes and, to generate HDL in which the NFA circuit is described, after that, to configure the NFA circuit on a hardware device and to achieve a pattern matching device using it.

Moreover, the Multibyte NFA generated in this embodiment is addressed to not only Exact Match but also the regular expression per se, further, it is possible to achieve the pattern matching device using an NFA circuit using the Multibyte NFA which can discriminate a position where the pattern is matched in the input character string alone by designating the operation mode.

Moreover, in this embodiment, similar to the first, second and third embodiments, it is possible to configure by the Multibyte NFA circuit which cannot discriminate a position where the pattern is matched in the input character string alone depending on the operation mode designation and, it is possible to achieve the pattern matching device using effective NFA circuit in accordance with the intended use.

Moreover, the data processing device 8 and the storage device 9 of the above-described embodiment is configured that the Configuration data conversion section 26 and the Configuration data storage section 34 are added to the data processing device 2 and the storage device 3 of the first embodiment but, it may be configured that the Configuration data conversion section 26 and the Configuration data storage section 34 are added to the data processing device 5 and the storage device 3 of the second embodiment.

It may generate the Configuration data from the HDL which is generated by one achieved by the regular expression—HDL conversion program 7 in the third embodiment.

Furthermore, in this embodiment, in the pattern matching device 12, the data input section 121 the pattern matching section 122 and the results output section 123 are configured on individual hardware devices each of which are capable of reconfiguration but, these three sections may be configured on same hardware device which is capable of reconfiguration and, for example the data input section 121 and the results output section 123 may be configured on same hardware device which is capable of reconfiguration and the pattern matching section 122 may be configured on another hardware device which is capable of reconfiguration, and it may configured by other various variation. In addition, these may be configured on a hardware device which cannot reconfigure, for example, being Application Specific Integrated Circuit (ASIC) using the generated HDL.

Here, If both of or either of the data input section 121 and the results output section 123 are configured on the hardware device which is capable of reconfiguration and on which the pattern matching section 122 is configured, it can be applied by reading out, by the Configuration data, conversion section 26, not only the HDL in which the NFA circuit generated by the HDL conversion section 23 is described but also the HDL in which these circuits are described and, generating the Configuration data.

In the fourth embodiment of the present invention, similar to the first, second and third embodiments, it is possible to perform similar process not only to NFA but also to DFA.

### INDUSTRIAL APPLICABILITY

The present invention can be applied to an HDL generating system in which an NFA circuit for performing a pattern matching processing using a regular expression is described and a generating program, as an applying example.

Configuring an NFA circuit by the HDL generated by the present invention, it can be applied for a pattern matching device for performing a high-speed pattern matching processing using the regular expression.

Upon adding a packet processing circuit to the pattern matching device, it can be applied for a Network Intrusion Detection System (NIDS) and a Network Intrusion Protection System (NIPS) and, it can be applied for an NFA circuit generating system for hardware accelerator which is substituted for a pattern matching processing based on software loaded on a personal computer and a work station, generating program and regular expression search hardware accelerator device and the like.

The present invention can apply anything and is not limited on possibility for use, if the present invention relates to a finite automaton generation system for string matching for multi-byte processing, an automaton circuit generation system, a method of generating the same, a method of generating a circuit, a generation program, a circuit generation program and a pattern matching device using the same, and a finite automaton circuit for string matching for multi-byte processing.

While the present invention has been described by associating with some preferred embodiments and examples, it is to be understood that these embodiments and examples are merely for illustrative of the invention by an example, and not restrictive.

While it will be obvious to those skilled in the art that various changes and substitutions by equivalent components and techniques are eased upon reading the specification, it is believed obvious that such changes and substitutions fit into the true scope and spirit.

1-40. (canceled)

41. A finite automaton generating system for a string matching for multibyte processing comprising: means for generating, from a pattern using a regular expression, an NFA which has transition conditions consisting of plural number of characters and can discriminate a position where the pattern is matched in an input character string alone according to a final state where the state has reached.

42. The finite automaton generating system for a string matching for multibyte processing according to claim 41 wherein it can select and generate either a finite automaton which can discriminate the position where the pattern is matched in the input character string alone according to the final state where the state has reached or, a finite automaton which cannot discriminate the position where the pattern is matched alone, the number of states of the finite automaton being smaller than the finite automaton and a size of circuit thereof being capable of reducing.

43. A finite automaton generating system for a string matching for multibyte processing comprising: regular expression storage means for storing an input regular expression; 1-byte NFA conversion means for converting the regular expression stored in the regular expression storage means into a Non-deterministic Finite Automaton (NFA) having no ε transition and transiting with 1 byte; Multibyte NFA conversion means for converting the NFA having no ε transition and transiting with 1 byte into an NFA transiting with the number of processing bytes designated; and NFA storage means for storing the NFA converted by the Multibyte NFA conversion means.

44. The finite automaton generating system for a string matching for multibyte processing according to claim 43 wherein the Multibyte NFA conversion means has means for generating the NFA which has transition conditions consisting of plural number of characters and can discriminate a position where the pattern is matched in an input character string alone according to a final state where the state has reached.

45. The finite automaton generating system for a string matching for multibyte processing according to claim 43 wherein the Multibyte NFA conversion means can select, by designated operation mode, whether to generate the NFA which can discriminate the position where the pattern is matched in the input character string alone or, to generate the NFA which cannot discriminate the position where the pattern is matched in the input character string alone in accordance with an intended use.

46. The finite automaton generating system for a string matching for multibyte processing according to claim 43 wherein a conversion process in the Multibyte NFA conversion means can be simplified by adding a limitation in the 1-byte NFA conversion means, the limitation denoting that there are no transition from a final state to other states including own state for the NFA having no ε transition and transiting with 1 byte and converted from the regular expression.

47. The finite automaton circuit generating apparatus for a string matching for multibyte processing according to claim 43 wherein it comprises: regular expression storage means for storing an input regular expression; 1-byte NFA conversion means for converting the regular expression stored in the regular expression storage means into a Non-deterministic Finite Automaton (NFA) having no ε transition and transiting with 1 byte; Multibyte NFA conversion means for converting the NFA having no ε transition and transiting with 1 byte into an NFA transiting with the number of processing bytes designated; NFA storage means for storing the NFA converted by the Multibyte NFA conversion means; HDL conversion means for generating, from the NFA converted by the Multibyte NFA conversion means, a hardware description language in which a hardware circuit thereof is described; and HDL storage means for storing the hardware description language converted by the HDL conversion means.

48. The finite automaton circuit generating apparatus for a string matching for multibyte processing according to claim 47 wherein the Multibyte NFA conversion means has the NFA generating means.

49. The finite automaton circuit generating apparatus for a string matching for multibyte processing according to claim 47 wherein the Multibyte NFA conversion means can select, by designated operation mode, whether to generate the NFA which can discriminate the position where the pattern is matched in the input character string alone or, to generate the NFA which cannot discriminate the position where the pattern is matched in the input character string alone in accordance with an intended use.

50. The finite automaton circuit generating apparatus for a string matching for multibyte processing according to claim 47 wherein a conversion process in the Multibyte NFA conversion means can be simplified by adding a limitation in the 1-byte NFA conversion means, the limitation denoting that there are no transition from a final state to other states including own state for the NFA having no ε transition and transiting with 1 byte and converted from the regular expression.

51. A finite automaton circuit generating apparatus for a string matching for multibyte processing comprising: NFA generating means for generating, from a pattern using a regular expression, an NFA which has transition conditions consisting of plural number of characters and can discriminate a position where the pattern is matched in an input character string alone according to a final state where the state has reached.

52. The finite automaton circuit generating apparatus for a string matching for multibyte processing according to claim 51 wherein it can select and generate either a finite automaton which can discriminate the position where the pattern is matched in the input character string alone according to the final state where the state has reached or, a finite automaton which cannot discriminate the position where the pattern is matched alone, the number of states of the finite automaton being smaller than the finite automaton and a size of circuit thereof being capable of reducing.

53. A finite automaton generating method for a string matching for multibyte processing including: an NFA generating process for generating, from a pattern using a regular expression, an NFA which has transition conditions consisting of plural number of characters and can discriminate a position where the pattern is matched in an input character string alone according to a final state where the state has reached.

54. A finite automaton generating method for a string matching for multibyte processing including: storing an input regular expression; converting the regular expression stored into an NFA having no ε transition and transiting with 1 byte; converting the NFA having no ε transition and transiting with 1 byte into an NFA transiting with the number of processing bytes designated; and storing the NFA converted.

55. The finite automaton circuit generating method for a string matching for multibyte processing according to claim 54, wherein the method including: storing an input regular expression; converting the regular expression stored into an NFA having no ε transition and transiting with 1 byte; converting the NFA having no ε transition and transiting with 1 byte into an NFA transiting with the number of processing bytes designated; storing the NFA converted; generating, from the NFA stored, a hardware description language in which a hardware circuit thereof is described; and storing the hardware description language.

56. A finite automaton circuit generating method for a string matching for multibyte processing including a second NFA generating process for generating, from a pattern using a regular expression, an NFA which has a transition condition consisting of plural number of characters and can discriminate a position where the pattern is matched in an input character string alone according to a final state where the state has reached.

57. A finite automaton generating program for a string matching for multibyte processing causing a computer to execute: a third NFA generating process for generating, from a pattern using a regular expression, an NFA which has transition conditions consisting of plural number of characters and can discriminate a position where the pattern is matched in an input character string alone according to a final state where the state has reached.

58. A finite automaton generating program for a string matching for multibyte processing causing a computer to execute: regular expression storage process for storing an input regular expression; 1-byte NFA conversion process for converting the regular expression stored into an NFA having no ε transition and transiting with 1 byte; Multibyte NFA conversion process for converting the NFA having no ε transition and transiting with 1 byte into an NFA transiting with the number of processing bytes designated; and NFA storage process for storing the NFA converted.

59. The finite automaton circuit generating program for a string matching for multibyte processing according to the claim 58, wherein it causing a computer to execute: regular expression storage process for storing an input regular expression; 1-byte NFA conversion process for converting the regular expression stored in the regular expression storage means into an NFA having no ε transition and transiting with 1 byte; Multibyte NFA conversion process for converting the NFA having no ε transition and transiting with 1 byte into an NFA transiting with the number of processing bytes designated; NFA storage process for storing the NFA converted by the Multibyte NFA conversion process; HDL conversion process for generating, from the NFA converted by the Multibyte NFA conversion process, a hardware description language in which a hardware circuit thereof is described; and HDL storage process for storing the hardware description language converted by the HDL conversion process.

60. A finite automaton circuit generating program for a string matching for multibyte processing causing a computer to execute: a fourth NFA generating process for generating, from a pattern using a regular expression, an NFA which has transition conditions consisting of plural number of characters and can discriminate a position where the pattern is matched in an input character string alone according to a final state where the state has reached.

61. pattern matching apparatus comprising: the finite automaton circuit generating apparatus according to claim 47 and Configuration data conversion means for generating Configuration data which is configuration information of the hardware device to reconfigure from the hardware description language generated by the finite automaton circuit generating apparatus, wherein generated Configuration data is used to apply the finite automaton circuit on the hardware device which is capable of reconfiguration.

62. A finite automaton circuit for a string matching for multibyte processing comprising: the finite automaton circuit generating apparatus according to claim 47; and Configuration data conversion means for generating Configuration data which is configuration information of the hardware device to reconfigure from the hardware description language generated by the finite automaton circuit generating apparatus, wherein the finite automaton circuit is on a hardware device which is able to reconfigure using generated Configuration data.
